(19) United States
(12) Patent Application Publication
(10) Pub. No.: US 2008/0292244 A1
(43) Pub. Date: Nov. 27, 2008

(54) Optical fiber, sealing method for optical fiber end face, connection structure of optical fiber, and optical connector

(75) Inventors: Yoshihisa Kato, Hitachi (JP); Kanako Suzuki, Hitachi (JP); Yoshinori Kurosawa, Hitachi (JP); Kazumasa Ohsono, Hitachi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: HITACHI CABLE, LTD., Tokyo (JP)

(21) Appl. No.: 11/984,287

(22) Filed: Nov. 15, 2007

(30) Foreign Application Priority Data
May 21, 2007 (JP) 2007-134772

(51) Int. Cl. G02B 6/032; G02B 6/26; G02B 6/36

(52) U.S. Cl. 385/50; 385/125; 385/78

(57) ABSTRACT

An optical fiber includes a core, a clad formed around the core, a plurality of holes being formed in the clad, and a hardening resin having a moisture permeability equal to or less than 0.5 g/cm²·24 hr, in which the hardening resin is filled in a vicinity of an end face of the holes.

The present application is based on Japanese Patent Application No. 2007-134772 filed on May 21, 2007, the entire contents of which are incorporated herein by reference.

### BACKGROUND OF THE INVENTION

1. Field of the Invention

This invention relates to an optical fiber which includes plural holes extending in a longitudinal direction thereof, a sealing method for the optical fiber, a connection structure of the optical fiber, and an optical connector using the optical fiber.

2. Description of the Related Art

To increase speed of an optical communication network and an optical signal processing, an optical fiber having a larger capacity is necessary. As means for achieving such an increased speed, a photonic crystal fiber (PCF) in which multiple holes stretching in a longitudinal direction are formed, has been considered.

An example of a total reflection PCF is a holey fiber (HF), in which a plurality of holes are formed in a clad surrounding a Ge-doped core and an effective refractive index of the clad is decreased. Concerning the holey fiber, an effective relative refractive index difference of the core with respect to the clad is about 32% by forming the holes which have a refractive index of substantially 1. Thereby, the relative refractive index difference of the holey fiber can be made greater than that of a single mode fiber (SMF).

Conventionally, a butt connection by a mechanical splice or a connector connection is used for connecting optical fibers. The connector connection is a manner that optical fiber connectors including ferrules attached to edges of the optical fibers are mutually connected by butting each other.

However, when the optical fibers such as a holey fiber having holes are connected by the above connecting method, problems may occur.

For example, in case of the butt connection by the mechanical splice, a refractive index matching agent which is disposed between end faces of the optical fibers, may enter into the holes by a capillary phenomenon. When the refractive index matching agent having a refractive index as much as that of the core enters into the holes, the core is considered to be formed in the holes. Thus, light will be coupled to the core of the holes, and a connection loss will be increased.

In case of the connector connection, when an optical fiber end face and a ferrule end face are grinded (e.g., polished), grinding waste (e.g., contaminants) will enter into the holes. Thus, when repeating an attachment and a removal of the connector, the grinding wastes entering into the holes may be present at the optical fiber end face, a crack or a void may occur, and a long-term reliability may decrease.

To address these problems, the optical fiber end face may be sealed by injecting a matching oil, an ultraviolet curing resin, or a thermosetting resin into the holes (e.g., JP-A-2002-236234, JP-A-2002-323625).

However, according to the conventional sealing method for the optical fiber end face, although the holes of the optical fiber end face are sealed by hardening a hardening resin injected in the holes by an ultraviolet irradiation or a heat, where the hardening resin easily permeates a moisture, the moisture permeating through a sealing portion under a high humidity condition produces a condensation inside of the holes, and the transmission loss is extremely increased.

Further, according to the conventional connecting method, where an adhesive strength between the hardening resin and a glass is small, an air gap or a separation between the resin and an inner wall of the holes will occur easily due to a volume contraction of the hardening resin during hardening. Thereby, in a butt connection by the mechanical splice, the refractive index matching agent enters into the holes from a gap (e.g., separation), and the connection loss is increased.

Still further, according to the conventional optical connector, a reliability is decreased due to entry of a grind agent or a grinding waste into the gap. Additionally, if the hardening resin is too soft, a resin surface thereof may sag more than a glass surface in grinding, then the grinding waste etc. may settle in the sagging area, and a connection error may be caused thereby. Meanwhile, if a viscosity of the hardening resin is too large, more time is necessary to fill the resin into the holes by a required length, the length filled by the resin may become unequal, and a variation of a connection characteristic may occur.

### SUMMARY OF THE INVENTION

In view of the foregoing and other exemplary problems, drawbacks, and disadvantages of the conventional methods and structures, an exemplary feature of the present invention is to provide an optical fiber, a sealing method for the optical fiber, a connection structure of the optical fiber, and an optical connector, which have a high reliability.

(1) According to One Exemplary Aspect of the Invention, an Optical Fiber Includes:

a core;

a clad formed around the core, a plurality of holes being formed in the clad; and

a hardening resin having a moisture permeability equal to or less than 0.5 g/cm²·24 hr, the hardening resin being filled in a vicinity of an end face of the holes.

(2) According to Another Exemplary Aspect of the Invention, an Optical Fiber Includes:

a core;

a clad formed around the core, a plurality of holes being formed in the clad; and

a hardening resin which has an adhesive strength to the glass equal to or greater than 5 MPa and a hardness, after hardening, equal to or greater than 50 shore D, the hardening resin being filled in a vicinity of an end face of the holes.

(3) According to Another Exemplary Aspect of the Invention, a Sealing Method for an Optical Fiber, Includes:

setting an optical fiber which has a plurality of holes in a clad thereof;

filling a hardening resin in a vicinity of an end face of the holes, the hardening resin having a moisture permeability equal to or less than 0.5 g/cm²·24 hr; and hardening the filled hardening resin.

(4) According to Another Exemplary Aspect of the Invention, a Sealing Method for an Optical Fiber Includes:

setting an optical fiber which has a plurality of holes in a clad thereof,

filling a hardening resin in a vicinity of an end face of the holes, the hardening resin having an adhesive strength to the glass equal to or greater than 5 MPa and a hardness, after hardening, equal to or greater than 50 shore D; and

hardening the filled hardening resin.

(5) According to Another Exemplary Aspect of the Invention, a Connection Structure of an Optical Fiber Includes:

a first optical fiber comprising a core, a clad formed around the core, a plurality of holes being formed in the clad, and a hardening resin having a moisture permeability equal to or less than 0.5 g/cm²·24 hr, in which the hardening resin is filled in a vicinity of an end face of the holes; and

a second optical fiber connected to an end face of the first optical fiber,

wherein the first and second optical fibers are butt-connected through a refractive index matching agent.

(6) According to Another Exemplary Aspect of the Invention, a Connection Structure of an Optical Fiber Includes:

a first optical fiber comprising a core, a clad formed around the core, a plurality of holes being formed in the clad, and a hardening resin which has an adhesive strength to the glass equal to or greater than 5 MPa and a hardness, after hardening, equal to or greater than 50 shore D, in which the hardening resin is filled in a vicinity of an end face of the holes; and

a second optical fiber connected to an end face of the first optical fiber,

wherein the first and second optical fiber are butt-connected through a refractive index matching agent.

(7) According to Another Exemplary Aspect of the Invention, an Optical Connector Includes:

an optical fiber comprising a core, a clad formed around the core, a plurality of holes being formed in the clad, and a hardening resin having a moisture permeability equal to or less than 0.5 g/cm²·24 hr, in which the hardening resin is filled in a vicinity of an end face of the holes; and

a ferrule coupled with the optical fiber.

(8) According to Another Exemplary Aspect of the Invention, an Optical Connector Includes:

an optical fiber comprising a core, a clad formed around the core, a plurality of holes being formed in the clad, and a hardening resin which has an adhesive strength to the glass equal to or greater than 5 MPa and a hardness, after hardening, equal to or greater than 50 shore D, in which the hardening resin is filled in a vicinity of an end face of the holes; and

a ferrule coupled with the optical fiber.

According to the present invention, a reliability of the optical fiber, the sealing method for the optical fiber, the connection structure of the optical fiber, and the optical connector can be improved.

The above exemplary modifications may be made alone or in any combination thereof.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIGS. 1A and 1B show an optical fiber in a first exemplary embodiment according to the present invention, in which FIG. 1A is a front view and FIG. 1B is a side sectional view;

FIG. 2 is a view showing a connection loss characteristic of the optical fiber in the first exemplary embodiment;

FIGS. 3A-3C are views showing outsides of end faces of Example 3, Comparative Example 3, and Comparative Example 4, where FIG. 3A is a front view of Example 3, FIG. 3B is a front view of Comparative Example 3, and FIG. 3C is a front view of Comparative Example 4;

FIGS. 4A-4C are views showing sealing portions of Example 4, Comparative Example 5, and Comparative Example 6, where FIG. 4A is a vertical sectional view of Example 4, FIG. 4B is a vertical sectional view of Comparative Example 5, and FIG. 4C is a vertical sectional view of Comparative Example 6;

FIG. 5 is a sectional view showing a connection structure in the exemplary embodiment according to the present invention;

FIG. 6 is a view showing a connection loss characteristic according to the connection structure of the optical fiber of FIG. 5;

FIG. 7 is a sectional view showing an optical connector in a second exemplary embodiment according to the present invention;

FIG. 8 is a sectional view showing a step of filling a thermosetting resin into a ferrule; and

FIG. 9 is a sectional view showing a step of fixing a holey fiber to the ferrule.

### DETAILED DESCRIPTION OF THE EXEMPLARY EMBODIMENTS

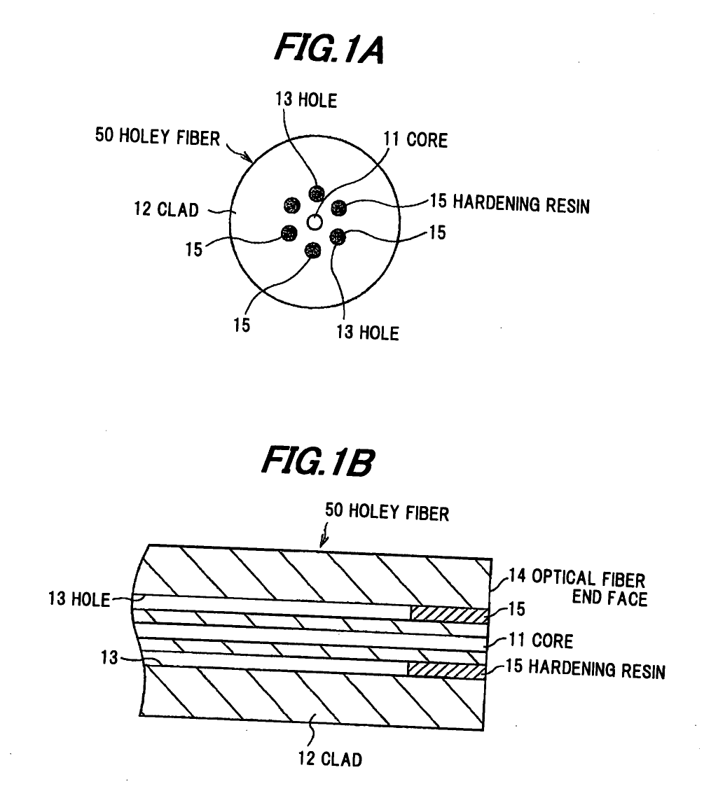

Referring now to the drawings, and more particularly to FIGS. 1A to 9, there are shown exemplary embodiments of the methods and structures according to the present invention.

### First Exemplary Embodiment

### Configuration of Optical Fiber

FIGS. 1A and 1B show an optical fiber in a first exemplary embodiment according to the present invention, in which FIG. 1A is a front view and FIG. 1B is a side sectional view of the optical fiber.

A holey fiber 50 includes a core 11 formed so as to be solid, a clad 12 formed around the core 11, and a plurality of holes 13 which are formed around the core 11 and have a refractive index of about 1. The holey fiber 50 further includes a hardening resin 15 filled in the holes 13 of an optical fiber end face 14. In FIGS. 1A and 1B, an end face of the core 11 is formed so as to constitute the same end face of the holey fiber 50.

The hardening resin 15 may be a resin having a moisture permeability, after hardening, equal to or less than 0.5 g/cm²·24 hr. If the moisture permeability of the hardening resin 15 is greater than 0.5 g/cm²·24 hr, then a condensation easily occurs in the holes under a high humidity condition, and the transmission loss is increased. The moisture permeability is preferably equal to or less than 0.3 g/cm²·24 hr.

In this case, the moisture permeability is based on a moisture permeability test method (e.g., cup method) of a moisture-proof packaging material, JIS Z 0208 (Japan Industrial Standards), and obtained by the test performed under conditions that a temperature is 40±5° C. and a humidity is 90±2%. A thickness of a sample is 50±5 μm.

Further, the hardening resin 15 may have an adhesive strength to glass equal to or greater than 5 MPa and a hardness, after hardening, equal to or greater than 50 shore D. If the adhesive strength of the hardening resin 15 to the glass is less than 5 MPa, then an air gap between the hardening resin 15 and a glass boundary occurs more easily due to a volume contraction of the hardening resin 15 while being hardened in the holes 13, a separation occurs more easily due to a vibration, etc. during grinding of the optical fiber end face 14.

Moreover, even if the adhesive strength to the glass is greater than 5 MPa, where the hardness of the hardening resin 15, after hardening, is less than 50 shore D, a part of the resin 15 may be removed more easily and a surface of the resin 15 may sag during grinding of the optical fiber end face 14. A grinding agent or a grind waste which settles there, causes an extreme degradation of a reliability of the connector connection.

In this case, the adhesive strength means a tensile shear adhesive strength which is provided by a force when two slide glasses (25(W)×75(D)×1(H) mm) are bonded in a surface having a length of 1 mm by a hardening resin, and broken by pulling in a velocity of 10 mm/min.

Further, the hardening resin 15 may have a volume contraction rate equal to or less than 5% and a viscosity before hardening equal to or less than 5 Pa·s. If the volume contraction rate of the hardening resin 15 is over 5%, then an air gap may occur more easily in the hardening resin 15 in the holes 13. Additionally, an air gap or a separation may occur more easily between the resin 15 and the glass boundary.

If the hardening resin 15 has a viscosity before hardening greater than 5 Pa·s, an operation filling the resin 15 into the holes 13 becomes difficult, and equally filling the resin 15 into each of the holes 13 becomes difficult. Therefore, the viscosity is preferably 0.1 to 3 Pa·s. If a viscosity is less than 0.1 Pa·s, then the capillary phenomenon increases, and it becomes difficult to keep the filled length equal.

Further, if the holey fiber 50 is connected by the mechanical splice, and if an air gap or a separation occurs in the hardening resin 15 filled in the vicinity of the end face of the holey fiber 50, then the refractive index matching agent provided at a connection face enters into the air gap or the separation part, and connection loss becomes greater.

Moreover, if the holey fiber 50 is connected by using an optical connector, and if an air gap or a separation occurs in the hardening resin 15 filled in the vicinity of the end face of the holey fiber 50, then the grind agent entering into the holes 13 from a cavity formed by the air gap or separation may be revealed externally.

Therefore, by using the hardening resin 15 having a volume contraction rate equal to or less than 5% and a viscosity equal to or less than 5 Pa·s, the filled length in the holes 13 can be kept equally, and the hardening resin 15 can be hardened without an air gap or separation occurring.

The hardening resin 15 is preferably limited to a resin having a volume contraction equal to or less than 5% and the viscosity equal to or less than 5 Pa·s. For example, an ultraviolet curing resin, a room-temperature setting resin which becomes hard while being left at room temperature, and a thermosetting resin which is hardened by heating can be used as the hardening resin 15.

### Advantage of the First Exemplary Embodiment

According to the first exemplary embodiment, the connection loss of the optical fiber can be reduced, and a long-term reliability can be increased.

### EXAMPLES

Next, examples of the present invention are described.

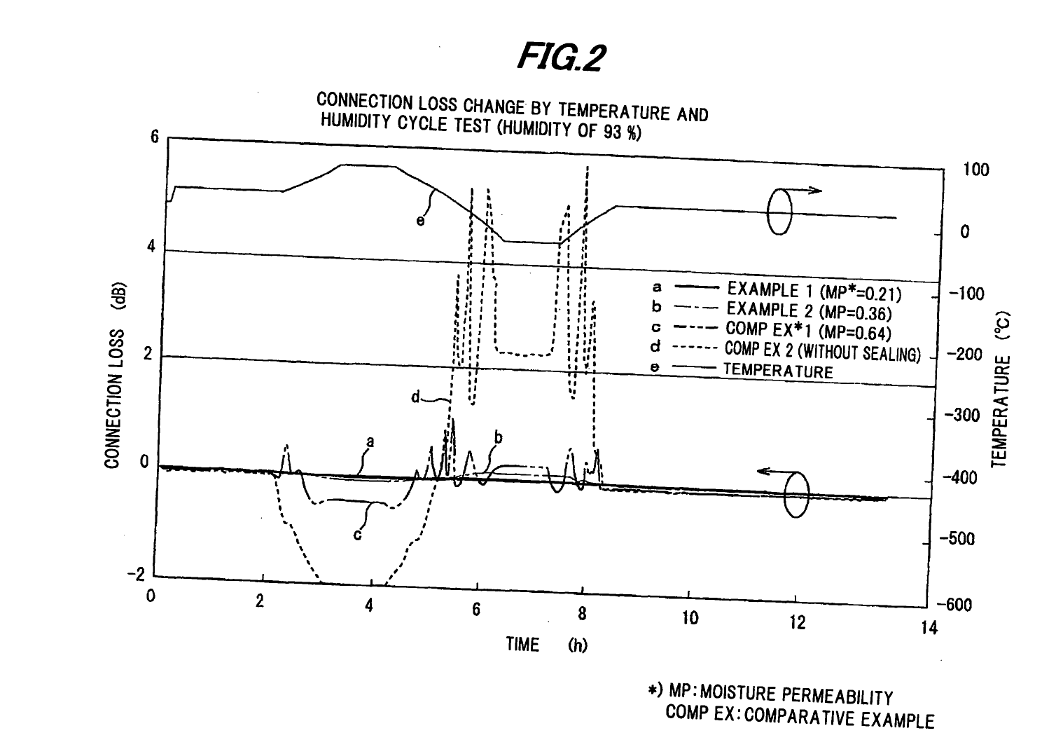

FIG. 2 is a view showing a connection loss characteristic of the optical fiber in the first exemplary embodiment.

This represents a change of the connection loss, where an SC (Single Coupling) connector is attached to the end face of the holey fiber 50 in which the holes 13 are sealed by the hardening resin 15, an optical fiber in which a universal SC connector is attached to a normal single mode fiber (SMF) is connected to the holey fiber 50, a connecting part thereof is entered into a constant-temperature bath, and a temperature and humidity cycle test (−40 to +70° C., 93% RH) is performed.

In FIG. 2, Example 1 is 0.21 g/cm²·24 hr in moisture permeability, Example 2 is 0.36 g/cm²·24 hr in moisture permeability, and Comparative Example 1 is 0.64 g/cm²·24 hr in moisture permeability.

Clearly, as shown in FIG. 2, a connection loss change of Comparative Example 1 having a high moisture permeability and Comparative Example 2 without sealing of the hardening resin 15, is large. On the other hand, Examples 1 and 2 with small moisture permeability have a smaller connection loss change, and can be adapted to a broad use environment.

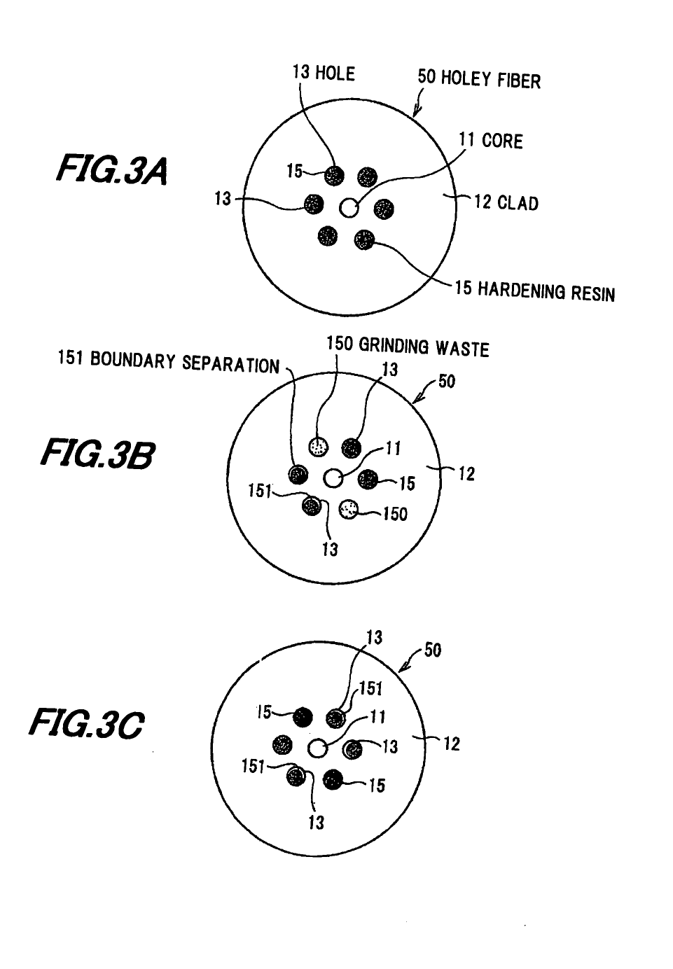

FIGS. 3A-3C are views showing outsides of end faces of Example 3, Comparative Example 3, and Comparative Example 4, where FIG. 3A is a front view of Example 3, FIG. 3B is a front view of Comparative Example 3, and FIG. 3C is a front view of Comparative Example 4. In this case, grinded end faces of the holey fiber 50 are shown after the holes 13 of the holey fiber 50 are sealed by the hardening resin 15 and attached to the SC connector, and an end face of the holey fiber 50 entered into a ferrule 21 and an end face 24 of the ferrule 21 are grinded.

As shown in FIG. 3A, the grinded end face of the holey fiber 50 of Example 3 is formed by the hardening resin 15 having a glass connection strength of 7 MPa and a shore D hardness of 82, and a clean face, without a separation or a grinding waste at a boundary between the holes 13 and the hardening resin 15, is obtained.

On the other hand, as shown in FIG. 3B, at the grinded end face of Comparative Example 3, a deposition of a grinding waste 150, or a boundary separation 151 between the holes 13 and the hardening resin 15, occurs due to using the soft hardening resin 15.

Further, as shown in FIG. 3C, at the grinded end face of Comparative Example 4, the boundary separation 151 between the holes 13 and the hardening resin 15 occurs due to using the hardening resin 15 having a small glass adhesive strength.

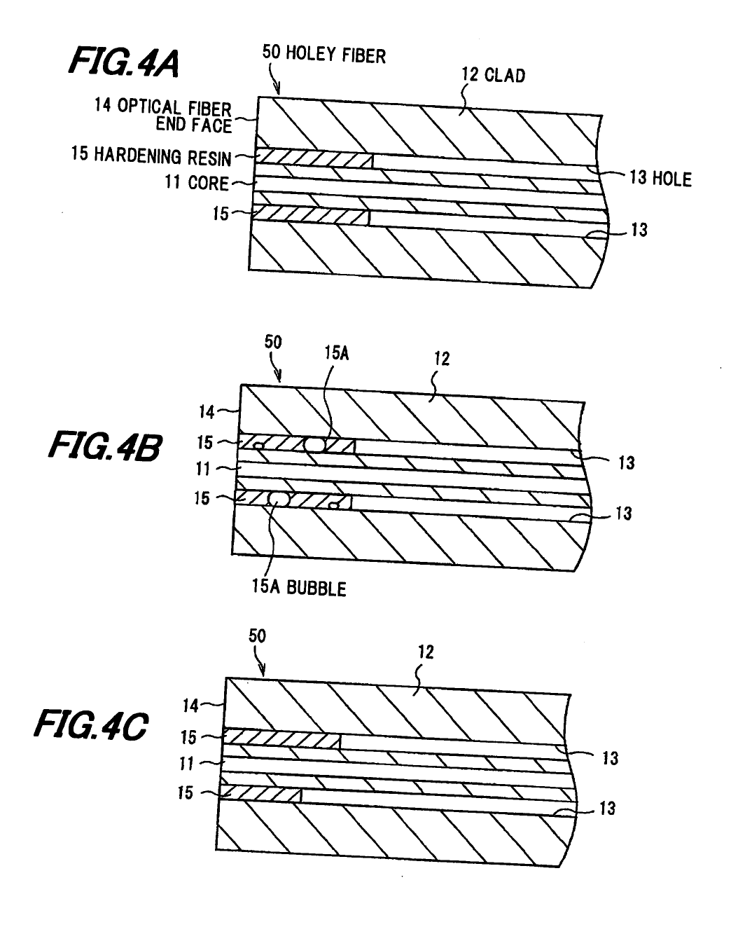

FIGS. 4A-4C show sealing portions of Example 4, Comparative Example 5, and Comparative Example 6, where FIG. 4A is a vertical sectional view of Example 4, FIG. 4B is a vertical sectional view of Comparative Example 5, and FIG. 4C is a vertical sectional view of Comparative Example 6. In this case, a fractured vertical section is shown so as to view a filled portion in which the hardening resin 15 having a different volume contraction rate and a different viscosity is filled in the holes 13 of the holey fiber 50 and hardened.

In Example 4 shown in FIG. 4A, each of the holes 13 is equally filled by the hardening resin 15, and an air gap, etc., does not occur. On the other hand, in Comparative Example 5 shown in FIG. 4B, a bubble, which is a fine air gap, occurs at the sealed portion by the hardening resin 15 having a high volume contraction rate. Additionally, in Comparative Example 6, a non-uniformity of the filled length occurs at the sealed portion by the hardening resin 15 having a high viscosity.

In this embodiment, the hardening resin 15 having a refractive index less than that of the clad 12, is used. If the refractive index of the hardening resin 15 is greater than that of the clad 12, then the holes 13 filled by the hardening resin 15 become a pseudo-core, and the transmission loss will easily occur.

In this case, the refractive index of the hardening resin 15 can be obtained by coating and hardening the hardening resin 15 at the end face of an SMF 60, and by measuring a return loss at the end face in a wavelength of 1550 nm. In this case, a temperature characteristic of the refractive index can be obtained by changing a measuring temperature of the return loss.

TABLE 1
λ = 1550 nm

| | | | | Comparative |
|---|---|---|---|---|
| | | Example 5 | Example 6 | Example 7 |
| Refractive | 60° C. | 1.440 | 1.429 | 1.461 |
| index λ | 25° C. | 1.444 | 1.432 | 1.466 |
| | 0° C. | 1.448 | 1.435 | 1.468 |
| | −10° C. | 1.449 | 1.436 | 1.469 |

| | | | |
|---|---|---|---|
| Connection loss (dB) | 0.05 to 0.2 | 0.05 to 0.1 | 3< |

Table 1 is a result of measuring the connection loss where the SC connector is connected to Example 5 and Example 6 in which the hardening resin 15 with a refractive index lower than that of the clad 12 is used, and to Comparative Example 7 in which the hardening resin 15 with a refractive index greater than that of the clad 12 is used, and connected to the SMF 60 to which a universal SC connector is connected.

Clearly, as shown in TABLE 1, the connection loss of Example 5 and 6 is small (e.g., in the range of 0.05 to 0.2 dB) in which the hardening resin 15 with a refractive index less than that of the clad 12 is used. On the other hand, the connection loss of Comparative Example 7 is greater than 3 dB in which the hardening resin 15 with a refractive index higher than that of the clad 12 is used.

### Connection Structure of the Optical Fiber

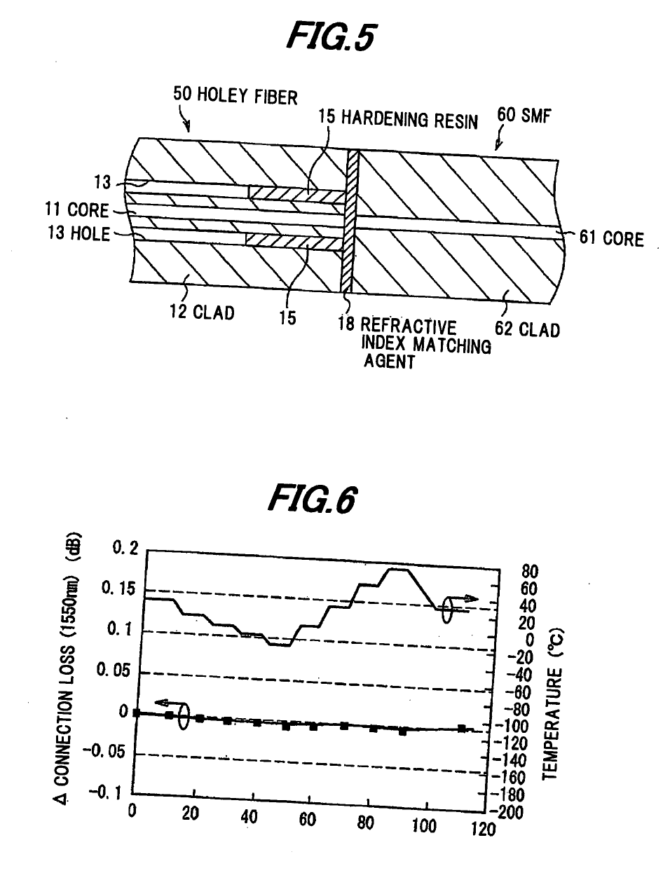

FIG. 5 is a sectional view showing a connection structure of the optical fiber in the exemplary embodiment according to the present invention.

As shown in FIG. 5, the holey fiber 50 is butt-connected to the universal single mode fiber (SMF) 60 (e.g., an end face of the holey fiber 50 abuts an end face of SMF 60) having a core 61 and a clad 62 through a refractive index matching agent 18. In the holey fiber 50, the hardening resin 15 is filled in the holes 13 in the vicinity of the optical fiber end face 14. In this case, the mechanical splice may be used for the butt connection of the holey fiber 50 and the SMF 60.

For example, an epoxy ultraviolet curing resin (“UV-1100” made by Daikin Industries, Ltd.) may be used as the hardening resin 15. This hardening resin 15 has a viscosity of 250 mPa·s, a moisture permeability of 0.2 g/cm²·24 hr, a refractive index of 1.449 (λ=1550 nm), a volume contraction rate of 4%, and a hardness of 82 shore D.

Referring to a connection method of the optical fiber, at first, a UV (ultraviolet) covering layer of the holey fiber 50 is removed by a stripper (e.g., stripping agent). Next, the holey fiber 50 is cut by a fiber cutter at a location where a bare wire of the holey fiber 50 has a length of 10 mm.

After cutting the holey fiber 50, the end face of the holey fiber 50 is soaked in the hardening resin 15 for about 10 seconds, and the hardening resin 15 is filled in the holes 13 of the holey fiber 50. After filling the hardening resin 15, the hardening resins 15, attached on a side face and the end face 14 of the holey fiber 50, is wiped away by a gauze and a connector cleaner, respectively.

Next, the side face of the holey fiber 50 is observed by an optical microscope. As a result, it is ascertained that the hardening resin 15 is filled in each of the holes 13 for 300 μm from the end face of the holey fiber 50.

Next, in order to harden the hardening resin 15, the hardening resin 15 is irradiated an ultraviolet ray of 2000 mJ/cm² from the side face thereof by an ultraviolet irradiator (“EX250 metal halide lamp” made by HOYA) and cured. Thereafter, the holey fiber 50 is inserted into a guide hole of the mechanical splice, the universal SMF 60 is inserted into another guide hole thereof, and the holey fiber 50 and the universal SMF 60 are connected.

In configurations of FIG. 5, the connection loss in a wavelength of 1550 nm is 0.11 dB, and thus, a connection by the mechanical splice can be achieved with a low loss. After connecting, even though kept in 23±2° C. and 55% RH for 24 hours, a changing of the connection loss does not occur.

### Connection Loss Characteristic of the Optical Fiber

FIG. 6 is a view showing a connection loss characteristic according to the connection structure of the optical fiber of FIG. 5. FIG. 6 represents a changing of the connection loss between the holey fiber 50 and the SMF 60 where an optical signal of a wavelength of 1550 nm is propagated in the holey fiber 50 and the SMF 60 which are connected as FIG. 5, and an ambient temperature thereof is changed in the range of −20 to +70° C.

In FIG. 6, a Δ connection loss means a loss ratio based on the connection loss at room temperature (25° C.) just after starting a measurement. As shown in FIG. 6, the delta connection loss is less than 0.006 dB, and is hardly changed in the range of −20 to +70° C. According to an observation of the side face of the connected holey fiber 50 by the optical microscope, entry of the refractive index matching agent 18 into the holes 13 is prevented by the hardening resin 15 filled in the holes 13.

Consequently, in the connection of the holey fiber 50 and the SMF 60 by the mechanical splice, the connection structure according to the exemplary embodiment can prevent entry of the refractive index matching agent 18 into the holes 13, reduce the connection loss, and keep the connection loss change minute with respect to a temperature change.

Although the connection method of the optical fiber using the mechanical splice is described, other connection methods can be used if the connection method includes a step that a hardening resin, which has a volume contraction rate by hardening equal to or less than 5% and a viscosity, before hardening, equal to or less than 5 Pa·s in 25° C., is filled in the vicinity of the end face of the holes 13 which are formed in the holey fiber 50, and a step that the filled hardening resin 50 is hardened.

### Configuration of Optical Connector

Next, an optical connector using the optical fiber of the exemplary embodiment is described.

### Second Exemplary Embodiment

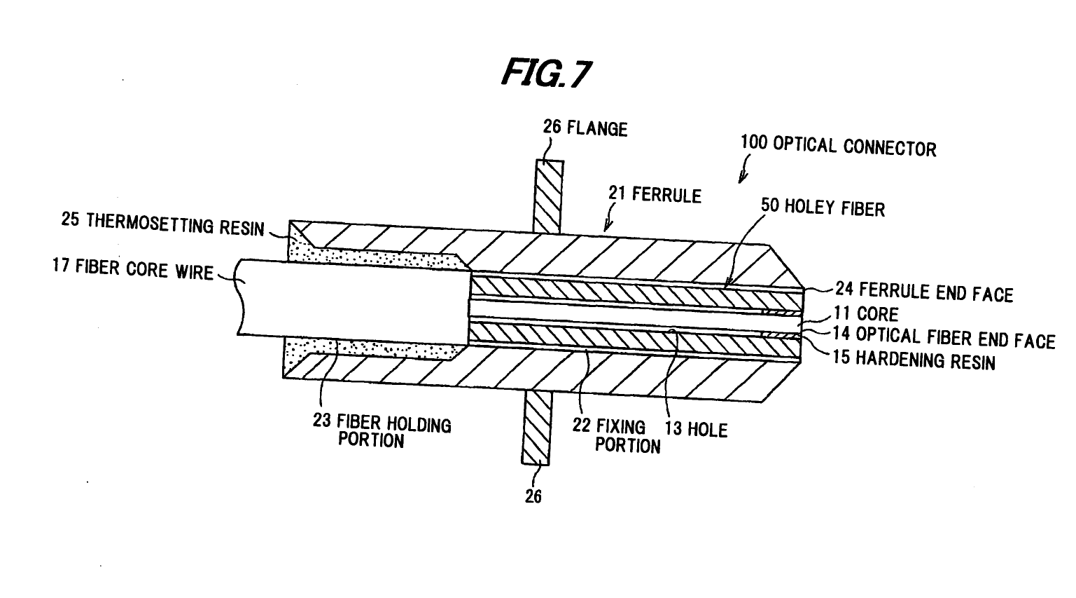

FIG. 7 is a sectional view showing an optical connector in a second exemplary embodiment according to the present invention. This optical connector 100 includes a ferrule 21 having a hollow fixing portion 22 for fixing the holey fiber 50 and a flange 26, and a fiber holding portion 23 which holds a fiber core wire 17 of the holey fiber 50 and is connected to the ferrule 21.

The hardening resin 15 is filled in the holes 13 of the holey fiber 50. Thereby, it is prevented that the grinding waste occurring when the optical fiber end face 14 and a ferrule end face 24 are grinded (e.g., polished), enters into the holes 13, and that a crack or a void occurs in the optical fiber end face 14 due to the grinding waste when the optical connector 100 is attached or removed.

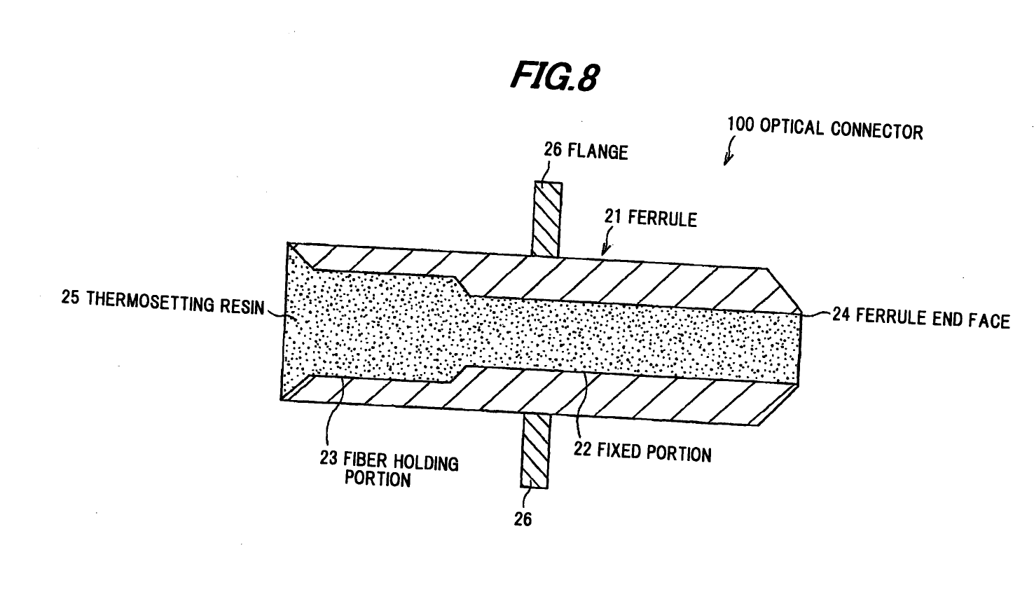

FIG. 8 is a sectional view showing a step of filling a thermosetting resin into a ferrule.

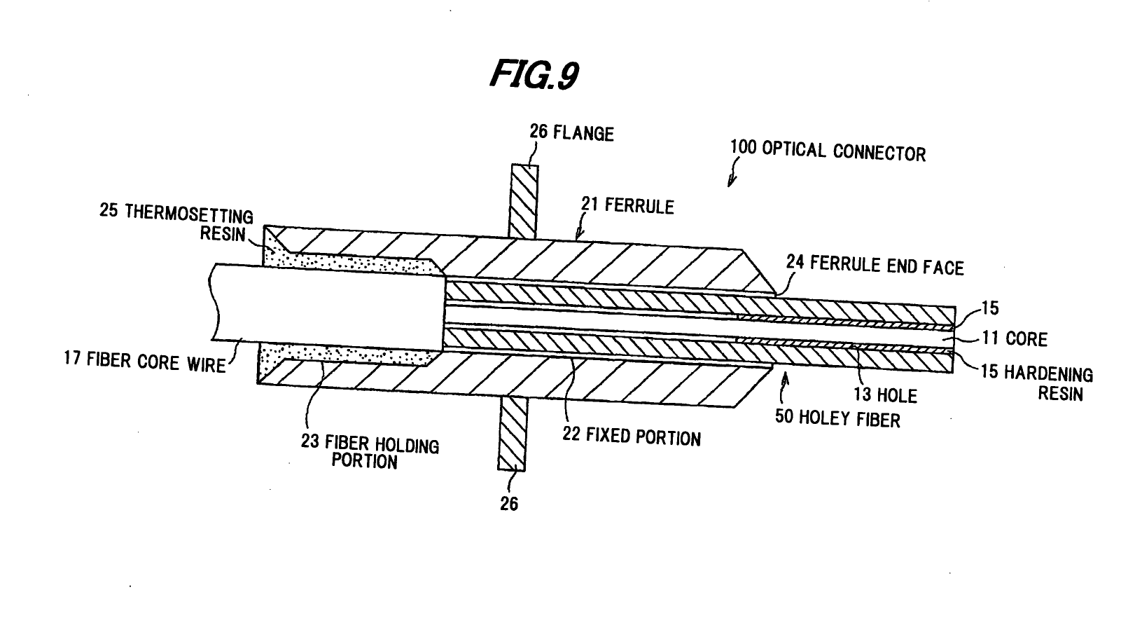

FIG. 9 is a sectional view showing a step of fixing a holey fiber to the ferrule.

Hereinafter, referring to FIGS. 8 and 9, an assembling method for the optical fiber is described.

### Assembling Method for the Optical Connector

At first, a UV covering layer of the holey fiber 50 is removed by the stripper, and the holey fiber 50 is cut by the fiber cutter at a location where a bare wire of the holey fiber 50 is 12±1 mm in length (adaptive to the SC connector). After cutting the holey fiber 50, the optical fiber end face 14 of the holey fiber 50 is soaked in the hardening resin 15, and the hardening resin 15 is filled in the holes 13 of the holey fiber 50 for 5±1 mm. After filling the hardening resin 15, the hardening resin 15 attached on the optical fiber end face 14 of the holey fiber 50 is wiped away by a dry gauze (“haize gauze” made by Asahi Kasei).

Next, after ascertaining the filled length by an optical microscope, in order to harden the hardening resin 15, the hardening resin 15 is irradiated with an ultraviolet ray of 2000 mJ/cm² from the side face thereof by the ultraviolet irradiator (“EX250 metal halide lamp” made by HOYA) and cured. Thereby, the holey fiber 50 is completed.

Next, as shown in FIG. 8, a thermosetting resin 25 is filled between the fixing portion 22 and the fiber holding portion 23 as an adhesive.

Next, as shown in FIG. 9, the holey fiber 50 in which the hardening resin 15 is filled in the holes 13 thereof as mentioned above, is inserted into the fiber holding portion 23 from the fixing portion 22.

Next, the ferrule 21 into which the holey fiber 50 is inserted is held in a constant-temperature bath kept at 85° C. for 40 minutes, the thermosetting resin 25 is hardened, and the holey fiber 50 is fixed to the ferrule 21.

Next, as shown in FIG. 7, after the holey fiber 50 is cut at a ferrule end face 24 of the ferrule 21, the ferrule end face 24 and the optical fiber end face 14 are grinded (polished), the ferrule 21 is attached to a housing for the SC connector, and the SC connector type optical connector 100 of the holey fiber 50 is completed.

When an attachment and a removal of the optical connector 100 assembled as mentioned above and the SC connector are repeated 500 times, no cracking or voids are found in the optical fiber end face 14. That is, by sealing the holes 13 in the vicinity of the optical fiber end face 14 by the hardening resin 15, damage to the optical fiber end face 14 caused by a foreign object (e.g., grinding waste) entering into the holes 13, can be prevented.

In other words, the optical connector manufactured by this production method can prevent an occurrence of a bubble or a separation and an entry of a grind waste into the holes 13, and a long-term reliability can be achieved.

### Other Exemplary Embodiments

Although the invention has been described with respect to specific exemplary embodiments for complete and clear disclosure, the appended claims are not to be thus limited but are to be construed as embodying all modifications and alternative constructions that may occur to one skilled in the art which fairly fall within the basic teaching herein set forth.

For example, although in the above exemplary embodiment the number of the holes 13 is six, the number is not limited thereto. An optical fiber or an optical connector can be formed by using a polymer-clad fiber (PCB) which has hundreds of holes. Additionally, a shape or a deposition of the holes 13 is not limited.

Further, a material of the hardening resin 15 filled in the holes 13 is not limited. For example, with respect to a holey fiber or a PCF in which a core thereof is formed by adding Ge to a pure silica glass, the same advantage can be obtained by using the hardening resin 15 which has a refractive index equal to or less than that of the pure silica glass, a moisture permeability by hardening equal to or less than 0.5 g/cm²24 hr, an adhesive strength to the glass equal to or greater than 5 MPa, a volume contraction rate of 5%, a viscosity before hardening equal to or less than 5 Pa·s, and a shore D hardness equal to or greater than 50.

Still further, in the above exemplary embodiment, the SC connector is represented as an optical connector, an FC connector can be formed by attaching an FC housing to the ferrule 21. Additionally, the FC connector or an MU connector (Miniature Universal Coupling) can be formed by using a ferrule for the FC connector or the MU connector.

Further, in the above exemplary embodiment, the holey fiber 50 and the universal SMF 60 are connected by the mechanical splice, but an optical fiber connected to an optical fiber having holes (e.g., holey fiber 50, PCF) is not limited to the universal SMF 60. A multi mode fiber (e.g., GI (Graded Index) fiber, SI (Step Index) fiber) can be used.

Additionally, an ultraviolet curing resin, a room temperature setting resin, or a thermosetting resin can be used as the hardening resin 15.

It is noted that Applicant's intent is to encompass equivalents of all claim elements, even if amended later during prosecution.

What is claimed is:

1. An optical fiber, comprising:
a core;
a clad formed around said core, a plurality of holes being formed in said clad; and
a hardening resin having a moisture permeability equal to or less than 0.5 g/cm²·24 hr, said hardening resin being filled in a vicinity of an end face of said holes.

2. The optical fiber according to claim 1, wherein:
said hardening resin has a volume contraction rate equal to or less than 5% and a viscosity before hardening equal to or less than 5 Pa·s at 25° C.

3. The optical fiber according to claim 1, wherein:
said hardening resin has an adhesive strength to a glass equal to or greater than 5 MPa and a hardness, after hardening, equal to or greater than 50 shore D.

4. A sealing method for an optical fiber, comprising:
setting an optical fiber which has a plurality of holes in a clad thereof;
filling a hardening resin in a vicinity of an end face of said holes, said hardening resin having a moisture permeability equal to or less than 0.5 g/cm²·24 hr; and
hardening said filled hardening resin.

5. The sealing method according to claim 4, wherein:
said hardening resin has a volume contraction rate equal to or less than 5% and a viscosity before hardening equal to or less than 5 Pa·s at 25° C.

6. The sealing method according to claim 4, wherein:
said hardening resin has an adhesive strength to a glass equal to or greater than 5 MPa and a hardness, after hardening, equal to or greater than 50 shore D.

7. A connection structure of an optical fiber, comprising:
a first optical fiber comprising a core, a clad formed around said core, a plurality of holes being formed in said clad, and a hardening resin having a moisture permeability equal to or less than 0.5 g/cm²·24 hr, in which said hardening resin is filled in a vicinity of an end face of said holes; and
a second optical fiber connected to an end face of said first optical fiber,
wherein said first and second optical fibers are butt-connected through a refractive index matching agent.

8. The connection structure according to claim 7, wherein:
said hardening resin has a volume contraction rate equal to or less than 5% and a viscosity before hardening equal to or less than 5 Pa·s at 25° C.

9. The connection structure according to claim 7, wherein:
said hardening resin has an adhesive strength to a glass equal to or greater than 5 MPa, and a hardness after hardening equal to or greater than 50 shore D.

10. An optical connector, comprising:
an optical fiber comprising a core, a clad formed around said core, a plurality of holes being formed in said clad, and a hardening resin having a moisture permeability equal to or less than 0.5 g/cm²·24 hr, in which said hardening resin is filled in a vicinity of an end face of said holes; and
a ferrule coupled with said optical fiber.

11. The optical connector according to claim 10, wherein:
said hardening resin has a volume contraction rate equal to or less than 5% and a viscosity before hardening equal to or less than 5 Pa·s at 25° C.

12. The optical connector according to claim 10, wherein:
said hardening resin has an adhesive strength to a glass equal to or greater than 5 MPa and a hardness, after hardening, equal to or greater than 50 shore D.
